(19) United States
(12) Patent Application Publication
(10) Pub. No.: US 2016/0224764 A1
(43) Pub. Date: Aug. 4, 2016

(54) DYNAMICALLY ENFORCING ACCESS CONTROL FOR DIGITAL DOCUMENT ALREADY OPENED ON A CLIENT COMPUTER

(71) Applicant: KONICA MINOLTA LABORATORY U.S.A., INC., San Mateo, CA (US)

(72) Inventors: Rabindra Pathak, San Jose, CA (US); William Chang, Sunnyvale, CA (US)

(73) Assignee: KONICA MINOLTA LABORATORY U.S.A., INC., San Mateo, CA (US)

(21) Appl. No.: 14/610,753

(22) Filed: Jan. 30, 2015

(51) Int. Cl. G06F 21/10; H04L 29/06; G06F 17/30

(52) U.S. Cl. CPC G06F 21/10; G06F 17/30011; H04L 63/102; G06F 2221/0713

(57) ABSTRACT

In a digital rights management (DRM) system having a server and a client, a method can dynamically enforce users' access rights to protected documents even after a document is already open in a viewer application on the client. The server has a DRM database storing various access rights of users with respect to documents, and grants access permissions upon request from the client to allow specific users to access specific documents. In addition to requesting access permissions at the time of opening a document, the client requests updated permissions from the server from time to time while the document is still open. If the updated permissions are different from those granted at the time the document was opened, the client dynamically disables/enables or modifies the functions of the viewer application based on the updated permissions while the document is still open.

### BACKGROUND OF THE INVENTION

1. Field of the Invention

This invention relates to a digital rights management system, and in particular, it relates to a digital rights management system that dynamically enforces access control for digital documents that have already been opened on a client computer.

2. Description of Related Art

Documents traditionally available only in hard copies are increasingly also available in digital copies. In fact many documents nowadays are prepared, generated, stored, distributed, accessed, read or otherwise used electronically in digital file formats such as the Portable Document Format (PDF). With the wide use of digital documents and digital document processing, digital rights management systems (“DRM” or “RMS”) are increasingly implemented to control user access and prevent unauthorized use of digital documents. The rights involved in using a digital document may include the right to view (or “read”) the digital document, the right to edit (or “write”) the digital document, the right to print the digital document in hard copies, the right to copy the digital document, etc. A user may access a digital document by acquiring (or being assigned) one or more of these rights.

DRM systems are generally implemented for managing users' rights to the digital documents stored in the systems. In a current DRM system, each digital document is associated with a rights management policy (or simply referred to as policy in this disclosure) that specifies which user has what rights to the document, as well as other parameters relating to access rights. Many such policies are stored in a DRM server (also called RMS server). The server also stores a database table that associates each document (e.g. by a unique ID, referred to as document ID or license ID) with a policy (e.g. by policy ID). Each digital document may also have metadata that contains the document ID. When a user attempts to access a document (either a document residing on a server or a document that has been downloaded or copied to the user's computer) using an application program such as Adobe™ or Acrobat™ or Acrobat™ Reader™, the application program on the client computer contacts the RMS server to request permission. The server determines whether the requesting user has the right to access the document in the attempted manner (view, edit, print, etc.), by determining the policy associated with the document and then referring to the content of that policy. The server then transmits an appropriate reply to the application program to grant or deny the access. If access is granted, the server's reply may contain a decryption key for the client computer to decrypt the document.

The description herein of the structures, functions, interfaces and other relevant features, such as digital rights policies, application programming interface (API) for rights management and policies, etc., of existing DRM systems may at times incorporates, references or otherwise uses certain information, documents and materials from publicly and readily available and accessible public information, e.g., for Adobe™ LiveCycle™: “Rights Management” (URL http://help.adobe.com/en_US/livecycle/10.0/Overview/WS92d06802c76abadb2c8525912ddcb9aad9-7ff8.html), “Programmatically applying policies (a subsection of ‘Rights Management’)”, (URL http://help.adobe.com/en_US/livecycle/10.0/Overview/WSb96e41f8a4ca47a9-4882aeb5131190eddba-8000.html), “LiveCycle® ES Java™ API Reference” (URL http://livedocs.adobe.com/livecycle/es/sdkHelp/programmer/javadoc/index.html), etc. The Microsoft™ ADRMS system is also a digital rights management system.

### SUMMARY

The present invention is directed to a DRM method and related apparatus that substantially obviates one or more of the problems due to limitations and disadvantages of the related art.

An object of the present invention is to dynamically enforce access control for a digital document even when the document is already open on the client computer.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method, implemented on a client of a digital rights management system that includes a server and the client, for managing access to digital documents, the method including: (a) upon receiving a user command to open a document, transmitting an authorization request to the server, the authorization request includes a user ID of the user and a document ID of the document; (b) receiving a reply from the server which includes an original list of permissions; (c) based on the original list of permissions, opening the document in a viewer application and enabling or disabling one or more functions of the viewer application; (d) while the document is open in the viewer application, transmitting an update request to the server, the update request including the user ID of the user and the document ID of the document; (e) receiving an updated reply from the server which includes an updated list of permissions; and (f) based on the updated list of permissions, automatically and without user interaction, performing at least one action selected from a group of actions consisting of: closing the document in the viewer application, disabling at least one function of the viewer application that was previous enabled, enabling at least one function of the viewer application that was previous disabled, and adjusting settings of at least one function of the viewer application.

The step of transmitting the update request may be performed repeatedly at predetermined time intervals, or in response to receiving a predetermined user command or in response to detecting a change in a condition of the client.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a DRM system including an RMS server and a client according to an embodiment of the present invention.

FIG. 2 schematically illustrates a method for dynamically enforcing access control for a digital document according to an embodiment of the present invention.

FIG. 3 illustrates a portion of an exemplary program that can be used to implement an embodiment of the present invention.

### DETAILED DESCRIPTION OF PREFERRED EMBODIMENTS

Conventional DRM systems can only enforce static document protection. That is, the user's access permissions with respect to a protected document (i.e. a document managed by the DRM system) are determined at the time the user attempts to open the document on the client computer. After the document is opened, the user's access permissions continues unchanged until the document is closed by the client computer. Even if the access rights for the user has changed at the RMS server during the time the document is open, the user's access permission at the client are not interrupted or changed. Only after the user closes the document and subsequently attempts to open the document again can new access rights be applied to the document. This is because in conventional DRM systems, the viewer application on the client computer only communicates with the RMS server once when it opens the protected document. Once the document is open, the view application does not communicate with the RMS server again. Therefore, if any rights are changed on the RMS server while the document is open, the viewer application is unaware of it; the changes are effective only after the viewer applications closes and then opens the document the next time.

This is undesirable in many situations. For example, if the RMS server revokes a user's viewing rights to a document while the document is still open on the user's computer, the user can continue to view the document even after the RMS server's revocation. In another example, assume that the user is granted rights to print a certain number of copies of a document, and that when the user attempts to open the document, he still has remaining rights to print at least one copy. At this time the server will grant the user rights to view and print the document. While the document is open on the client, the user will be able to print any number of copies even if the number exceeds the print right he has.

Embodiments of the present invention provide a method by which dynamic access control can be applied on already opened document, so that any policy changes can be dynamically applied when the document is still open on the client computer.

In one example of a practical use scenario, while a document is open on the client computer, if the RMS server revokes all rights to the document, the viewer application on the client will close the document and optionally display a message to the user that the document is revoked and user no longer has permission to access it.

In another example of a practical use scenario, a user opens a document for which he is authorized to print N copies. After the user prints N copies, if he tries to print another copy, the viewer application will deny user the ability to print.

In another example of a practical use scenario, a user opens a document for which he is authorized to print N copies. When the user attempts to print the document, the user interface display for the print function will only allow the user to specify up to N copies for printing.

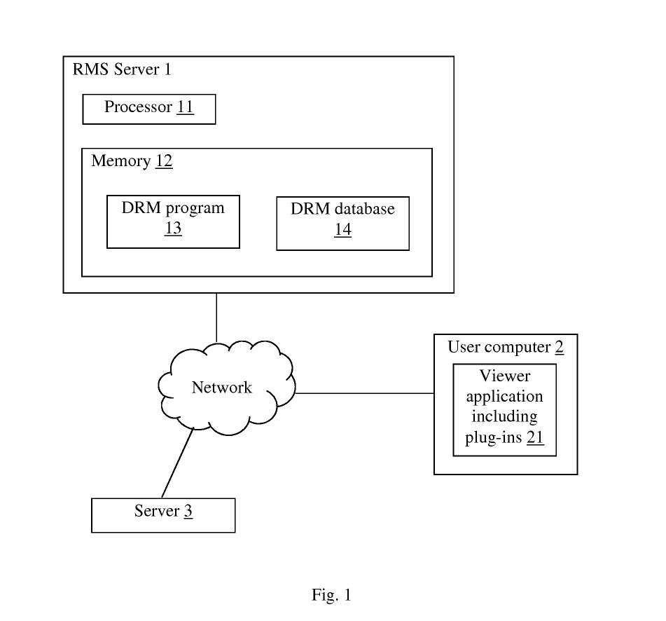

FIG. 1 schematically illustrates a DRM system according to an embodiment of the present invention. The system includes a digital rights management server (RMS server) 1 and a user computer (client) 2, and optionally other servers 3 such as a server storing copyrighted digital documents, a server that handles purchases transactions, etc. The RMS server 1 includes necessary hardware including a process 11 and a memory 12 which stores a DRM program 13 and a DRM database 14. The client computer 2 has a processor (not shown) and a memory that stores a viewer application 21.

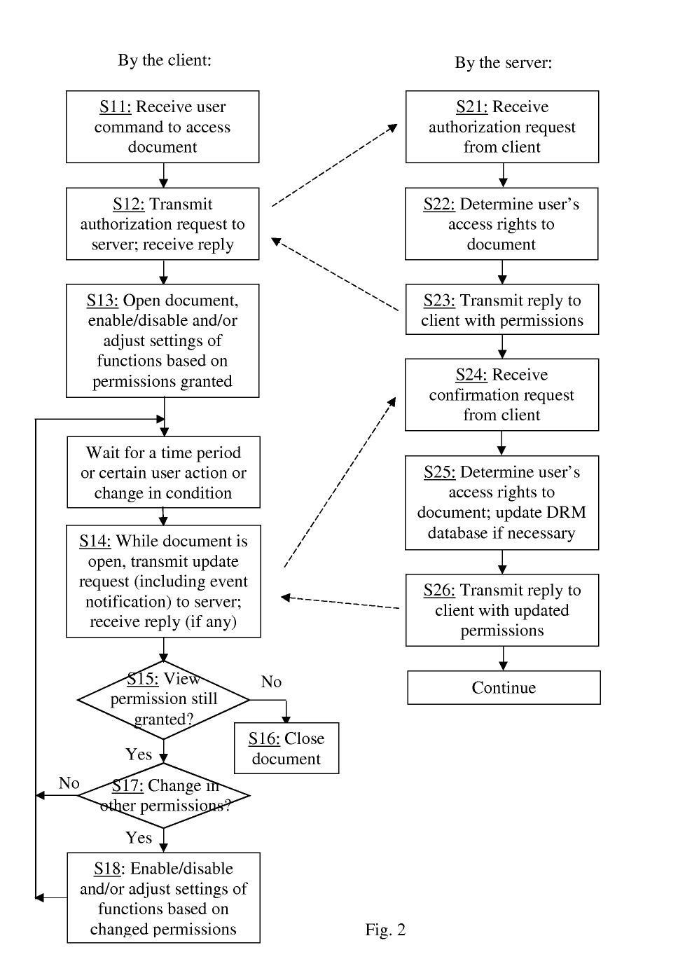

FIG. 2 schematically illustrates a DRM method executed by the system shown in FIG. 1 for dynamically enforcing access control for a digital document according to an embodiment of the present invention. The steps executed by the server may be implemented by the DRM program 13, and the steps executed by the client may be implemented by the viewer application 21. In some implementations, the viewer application is based on commercially available software such as Adobe™ Acrobat™ or Reader™, and the steps described herein can be implemented using plug-ins that integrate with the commercially available software.

The process starts when the client computer 2 receives a command from the user to access a protected digital document (step S11). The client transmits an authorization request to the server to request access permissions (step S12). The request contains a document ID of the document, which can be obtained from the document itself as a part of the metadata of the document, and a user ID of the user. The server 1, upon receiving the authorization request from the client (step S21), refers to the DRM database 14 to determine whether the user has any access rights to the document (step S22). Various types of access rights may be managed by the DRM system, including the rights to view, print, copy, edit, etc. a document. Based on the determination, the server transmits a reply to the client that contains a list of permissions or no permission (step S23). The reply additionally includes an encryption key that can be used by the client to decrypt the document (if any permission is granted).

Upon receiving the server's reply, the viewer application on the client decrypts the document and opens it (if the requested permission is granted) (step S13). This typically includes displaying the content of the document on the display screen of the client computer. Note that if the action commanded by the user is a direct printing or copying of the document without displaying its content on the screen, the dynamic control described in this embodiment will not be needed because such actions are typically completed in a relatively short amount of time and the document is closed immediately thereafter.

When opening the document in step S13, the viewer application will enable or disable, or adjust settings of, various functions of the viewer application 21 according to the permission granted for the document. For example, if print permission is not granted, then the viewer application will disable its print function when opening the document, e.g. by disabling the menu items for print. This may be implemented in suitable ways depending on the viewer application, some examples of which are described later.

While the document is still open on the client, the client 2 automatically and repeatedly transmits update requests to the RMS server 1 in order to determine whether the original access permissions that were granted at the time of opening the document are still valid (step S14). The client may transmit the update requests periodically at predetermined time intervals. In addition, the client may transmit an update request to the server when the user attempts to perform certain functions; for example, when the user attempts to print the document, the client may transmit an update request to the server to determine the user's print right at that time. The update request again contains the document ID and the user ID; it may contain additional information, such as a report of the user's access activities during the current document open session, to aid the server in updating the user's access rights. For example, the report may inform the server that during the current document open session, the user printed two copies of the document.

When the server receives the confirmation request (step S24), it refers to the DRM database 14 to determine whether the user has any access rights to the document (step S25), and transmits an updated reply to the client (step S26). The updated reply contains a list of permissions that are granted at the time of the update request (updated list of permissions). If the update request received from the client in step S24 contains a report of the user's access activities during the current document open session, the server updates the user's access rights in the DRM database accordingly. For example, the user's print rights may need to be updated based on the report that the user printed two copies of the document during the current document open session. It should be noted that although steps S25 to S26 and steps S21 to S23 are shown as a separate set of steps, they may in fact be the same from the perspective of the server.

On the client, if the permissions contained in the server's updated reply are different from the original permissions received in step S12, the client implements the new permissions dynamically, i.e. while the document is still open, even though the user has not initiated any changes (steps S15 to S18).

Specifically, if the new permissions no longer includes a view permission (“No” in step S15), the client closes the document (step S16). Optionally, a message may be displayed to advise the user that he no longer has the permission to view the document.

If the updated print, edit, or other permissions are different from the original permissions (“Yes” in step S17), the client dynamically enables or disables, or adjusts settings of, the print, edit, or other functions of the viewer application accordingly (step S18). For example, if print permission was granted originally when the document was opened, the “print” menu item would be enabled in the viewer application at that time; when the updated reply indicates that print permission is no longer granted, the viewer application dynamically disables the print menu item, e.g. causing it to be greyed out in the menu bar. In another example, the settings of the print function are adjusted so that the number of copies the user is allowed to print (when the user interacts with the Print dialog box) is set based on the updated reply from the server.

The dynamic actions performed in steps S15 to S18 may be implemented by any suitable programming techniques. In some embodiments, the viewer application is based on commercially available software such as Adobe™ Acrobat™ or Reader™ and the various actions may be implemented using plug-ins that integrate with the commercially available software. Using plug-ins for Adobe™ Acrobat™ or Acrobat™ Reader™ as an example, the various dynamically performed actions described above may be implemented as follows. The descriptions below reference the Acrobat core API described in, for example, Developing Plug-ins and Applications, Version 8.1, by Adobe Systems Inc., April 2007, publicly available at http://www.adobe.com/content/dam/Adobe/en/devnet/acrobat/pdfs/plugin_apps_developer_guide.pdf. References are made specifically to pages 20 and 88-96 of the document.

Closing the document: This may be done programmatically by invoking the AVMenuItemExecute method to simulate a user selection of the “close” menu command.

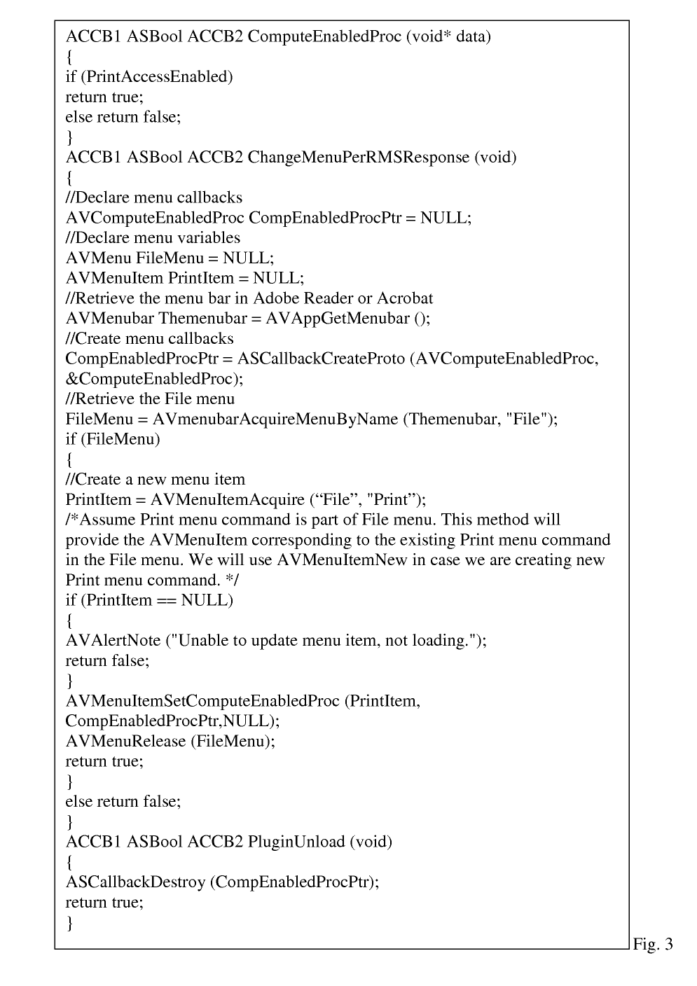

Enabling/disabling a built-in menu item such as Print: Print is a built-in menu item in the standard menu bar in Acrobat and Reader. To enable or disable the Print menu item, the AVMenuItemAcquire method is invoked to acquire the Print menu item, and a Compute-enabled callback function for the Print menu item is provided. A Compute-enabled callback function is an attribute of a menu item (an AVMenuItem object) which computes whether the menu item is enabled. The Compute-enabled callback function provided by they plug-in will checks a “PrintEnabled” parameter stored on the client; this parameter is established and dynamically modified by the plug-in based on the reply received from the server in steps S12 and S14. As a result, the Print menu item can be dynamically enabled or disabled. An example of a plug-in program to accomplish this is shown in FIG. 3.

Enabling/disabling a menu item created by the plug-in: A plug-in program can create menu commands, which enable the user to interact with the plug-in by clicking the menu item. The plug-in creates an associated Compute-enabled callback function when it creates the menu item. The Compute-enabled callback function will checks a “PrintEnabled” parameter which is stored on the client and which is dynamically updated in the manner described above to achieve dynamic enabling/disabling of the function.

In another embodiment, the system enforces users' print rights by dynamically adjusting settings of the Print dialog box of the viewer application 21 to control the number of copies the user is allowed to print. To implement this embodiment, the RMS server 1 maintains, in the DRM database 14, information about how many copies a user is allowed to print for particular documents, and how many copies he has already printed. Alternatively, the server may maintain information about how many copies a user is still allowed to print for particular documents. The process flow of this embodiment can be summarized in the same flowchart as shown in FIG. 2 but some of the steps include additional actions described below.

When the client tries to print a protected document, the client transmits an update request to the server to request print permission (step S14). The determining step S25 on the server includes determining, by referring to the DRM database 14, how many copies of the document (which may be zero) the user is allowed to print. The number of remaining allowed copies is included in the reply to the client (step S26). In step S18 on the client, if the number of remaining allowed copies is zero, the Print dialog will not open and a message may be display to advise the user that he has no print permission; if the number of remaining allowed copies is non-zero, a modified Print dialog box is displayed to the user. The Print dialog box allows the user to set various print settings such as paper orientation, paper size, color or monochrome printing, number of copies to print, etc. The dialog box is modified by the plug-in to set a maximum number of copies for print, the maximum number of copies being equal to the number of remaining allowed copies received from the server. Thus, the dialog box only allows the user to specify a number of copies that does not exceed the maximum number. Optionally, when the user tries to enter a number larger than the maximum number, a message may be displayed to advise the user of the restriction. In addition, after the print operation is complete, the client transmits another update request to the server (step S14 repeated), which includes a report regarding the number of copies the user has just printed. Based on the reported information, the server updates the DRM database regarding the user's print rights, e.g. updating the stored number of copies already printed or number of copies remaining (step S25), and transmits an updated reply to client accordingly. This process is repeated each time the user tries to print the document.

In another embodiment of the dynamic access control method, the DRM system controls the physical location where the user is allowed to access the document. For example, if the client is a laptop or tablet computer, a smart phone, or other mobile devices, the access rights managed by the DRM system may specify the physical locations where the client must be located in order for the user to have access rights to certain documents. The location restrictions are stored as a part of the DRM database, and the authorization request or the periodic update request from the client includes information identifying the current physical location of the client. The current location information may be obtained using GPS or cellular technology or other suitable technologies. If the reply from the RMS server indicates that the user does not have or no longer has access to the document, the client will not open the document or will closes the document if it is already open. This accomplishes dynamic access control based on physical location of the client computer.

As mentioned earlier, the client may transmit update requests to the RMS server periodically at predetermined time intervals, or at times when the user attempts to perform certain functions such as print. More generally, the client may transmits an update request to the server any time certain events occur on the client; an event may be, for example, a user action such an attempt to print, a change in a conditions of the client such as a movement of the physical location of the client device, etc. In such a case, the update request may be in the form of an even notification, which will contain information regarding the event in addition to the user ID and document ID. An event notification is a notification that does not require a response from the server. A response is optional; for example, the server will transmit a response only if it determines that the event causes one or more changes in the user's permissions. The server will also update the DRM database 14 based on the report in the event notification if appropriate. Event notifications are useful, for example, in the above example where access control is based on physical location of the client device. In this example, the client transmits event notifications to the RMS server when a change of physical location is detected by the client; if the event does not cause any change in the user's permission, the server does not transmit any response, but if the change of location results in the user no longer being permitted to view the document, the server will transmit a response to the client and the client will close the document based on such response.

In this disclosure, the term “update request” broadly includes requests for which responses are required as well as event notifications for which responses are optional. In the process shown in FIG. 2, step S14 may be a step of transmitting an event notification, in which case step S26 is optional a reply may or may not be received in step S14.

As can be seen from the above descriptions, embodiments of the present invention can dynamically enforce access rights on already opened documents when the rights are changed at the RMS server, and can enforce the access rights regarding the number of copies that can be printed.

It will be apparent to those skilled in the art that various modification and variations can be made in the digital rights management method and related apparatus of the present invention without departing from the spirit or scope of the invention. Thus, it is intended that the present invention cover modifications and variations that come within the scope of the appended claims and their equivalents.

1. In a digital rights management system including a server and a client for managing access to digital documents, a method implemented on the client, comprising:
(a) upon receiving a user command to open a document, transmitting an authorization request to the server, the authorization request includes a user ID of the user and a document ID of the document;
(b) receiving a reply from the server which includes an original list of permissions;
(c) based on the original list of permissions, opening the document in a viewer application and enabling or disabling one or more functions of the viewer application;
(d) while the document is open in the viewer application, automatically without any user initiated changes, transmitting an update request to the server, the update request including the user ID of the user and the document ID of the document;
(e) receiving an updated reply from the server which includes an updated list of permissions; and
(f) based on the updated list of permissions, automatically and without user interaction, performing at least one action selected from a group of actions consisting of: closing the document in the viewer application, disabling at least one function of the viewer application that was previous enabled, enabling at least one function of the viewer application that was previous disabled, and adjusting settings of at least one function of the viewer application.

2. The method of claim 1, wherein step (d) is performed repeatedly at predetermined time intervals.

3. The method of claim 1, wherein the at least one action performed in step (f) includes disabling a print function of the viewer application that was previously enabled.

4. The method of claim 1, further comprising: while the document is open in the viewer application, in response to receiving a predetermined user command, transmitting an update request to the server, the update request including the user ID of the user and the document ID of the document.

5. The method of claim 4, wherein the predetermined user command is a print command, and wherein in step (e), the updated reply further includes a number of allowed copies for print.

6. The method of claim 5, wherein in step (f) the at least one action includes adjusting a setting of a user interface display for the print command which specifies a maximum number of copies to be printed based on number of allowed copies for print received in the updated reply.

7. The method of claim 1, further comprising: while the document is open in the viewer application, in response to detecting a change in a condition of the client, transmitting an update request to the server, the update request including the user ID of the user and the document ID of the document.

8. The method of claim 1, wherein the update request includes information identifying a current physical location of the client.

9. A computer program product comprising a computer usable non-transitory medium having a computer readable program code embedded therein for controlling a client computer in a digital rights management system which includes a server and the client, the computer readable program code configured to cause the client to execute a process for managing access to digital documents, the process comprising:
(a) upon receiving a user command to open a document, transmitting an authorization request to the server, the authorization request includes a user ID of the user and a document ID of the document;
(b) receiving a reply from the server which includes an original list of permissions;
(c) based on the original list of permissions, opening the document in a viewer application and enabling or disabling one or more functions of the viewer application;
(d) while the document is open in the viewer application, automatically without any user initiated changes, transmitting an update request to the server, the update request including the user ID of the user and the document ID of the document;
(e) receiving an updated reply from the server which includes an updated list of permissions; and
(f) based on the updated list of permissions, automatically and without user interaction, performing at least one action selected from a group of actions consisting of: closing the document in the viewer application, disabling at least one function of the viewer application that was previous enabled, enabling at least one function of the viewer application that was previous disabled, and adjusting settings of at least one function of the viewer application.

10. The computer program product of claim 9, wherein step (d) is performed repeatedly at predetermined time intervals.

11. The computer program product of claim 9, wherein the at least one action performed in step (f) includes disabling a print function of the viewer application that was previously enabled.

12. The computer program product of claim 9, further comprising: while the document is open in the viewer application, in response to receiving a predetermined user command, transmitting an update request to the server, the update request including the user ID of the user and the document ID of the document.

13. The computer program product of claim 12, wherein the predetermined user command is a print command, and wherein in step (e), the updated reply further includes a number of allowed copies for print.

14. The computer program product of claim 13, wherein in step (f) the at least one action includes adjusting a setting of a user interface display for the print command which specifies a maximum number of copies to be printed based on number of allowed copies for print received in the updated reply.

15. The computer program product of claim 9, further comprising: while the document is open in the viewer application, in response to detecting a change in a condition of the client, transmitting an update request to the server, the update request including the user ID of the user and the document ID of the document.

16. The computer program product of claim 9, wherein the update request includes information identifying a current physical location of the client.
